(19) United States
(12) Patent Application Publication
(10) Pub. No.: US 2007/0230923 A1
(43) Pub. Date: Oct. 4, 2007

(54) Optical Disc Recording/Reproducing Device and Visible Image Recording Control Method

(75) Inventors: Yorio Takahashi, Ehime (JP); Shinji Inoue, Ehime (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Kadoma-shi (JP)

(21) Appl. No.: 11/629,536

(22) PCT Filed: Jun. 8, 2005
(86) PCT No.: PCT/JP05/10499

§ 371 Date: Dec. 14, 2006

(30) Foreign Application Priority Data
Jun. 14, 2004 (JP) 2004-174878

(51) Int. Cl. H04N 5/85

(52) U.S. Cl. 386/126

(57) ABSTRACT

An optical disc recording/reproducing device includes visible information recording control means (109D) for successively moving (S203) an optical pickup (102) from the recording start position at the inner circumference side by a traverse drive circuit (105) and a DC motor (118), and controlling laser light power to start write (S205) of visible information. A tracking drive circuit (104) and a tracking drive system (116) are operated and when the sift amount reaches a predetermined level or above, an optical pickup (101) is moved (S207) by a certain distance in the outer circumference direction by the traverse drive circuit (105) and DC motor (118). The tracking drive circuit (104) and tracking drive system (116) move (S209) the laser spot in the direction of the optical disc inner circumference. A shift amount of the tracking actuator is held when a boundary between the recorded area and an unrecorded area is detected. Control is returned to (S203) and the laser light power is controlled according to coordinate information in the circumferential direction to write visible information.

### TECHNICAL FIELD

The present invention relates to an optical disc recording/reproducing device capable of forming visible information such as characters and images on a plane (typically, referred to as “label plane”) of an optical disc by irradiation of the label plane with a laser beam. Herein, the label plane has no track and is provided on a reverse side to an information recording plane of the optical disc.

### BACKGROUND ART

An optical disc recording/reproducing device of this type is disclosed in Patent Document 1. This optical disc recording/reproducing device does not record digital data on an information recording plane on which digital information is recorded in form of pits, but records a visible image formed by a pit pattern. However, the optical disc recording/reproducing device has a problem that a digital data recordable capacity is decreased. In order to solve this problem, recently, Non-Patent Document 1 reports the following technique. That is, a heat sensitive layer that has no track and develops a color by addition of heat is formed on a label plane provided on a reverse side to an information recording plane of an optical disc. In an optical disc recording/reproducing device, this optical disc is attached to a spindle motor such that the label plane faces an optical pickup. Then, the optical disc is rotated at a certain angular velocity (CAV control) and, concurrently, an image of target visible information is supplied to the optical pickup in synchronization with this rotation; thus, a visible image is recorded on the label plane of the optical disc.

The optical pickup includes a laser diode. The laser diode has a controlled power for emitting a laser beam in such a manner that a laser beam used for accessing the information recording plane of the optical disc to thereby record digital information on the information recording plane is larger in power than a laser beam used for reading digital information already recorded on the information recording plane. A laser beam used for writing visible information to the label plane is similar in power to a laser beam used for writing the digital information to the information recording plane. In order to record a target image on the label plane, the laser diode irradiates the heat sensitive layer with the modulated laser beam so that the heat sensitive layer develops a color.

In a case that an image is written to the label plane, the optical pickup moves in a radial direction (a traverse direction) of the optical disc and a target image is developed on the label plane. In order to control the movement of the optical pickup in the traverse direction of the optical disc, as disclosed in Patent Document 1, positions of the optical pickup in the radial direction at different times are determined based on tracks originally provided for data recording. However, if a visible image is recorded on the label plane having no track, the position of the optical pickup in the radial direction of the optical disc must be controlled only by a driving amount of the optical pickup by a tracking actuator and a movement amount of the optical pickup by traverse driving.

According to this configuration, an image can be written to the label plane without use of a printer device prepared separately from the optical disc recording/reproducing device.

Patent Document 1: JP2003-203348A

Non-Patent Document 1: “LightScribe Simplifies CD/DVD Labeling”, Ramon G. Mcleod contributed to this report, Melissa J. Perenson, PC World, Monday, Jan. 12, 2004, searched on the Internet on May 28, 2004, URL: http://www.pcworld.com/news/article/0,aid,114211,00.asp

### DISCLOSURE OF THE INVENTION

### Problems to be Solved by the Invention

In a case that visible information is recorded on a label plane having no track, it is difficult to identify a recording position in a tracking direction. In an optical disc recording/reproducing device, when a stepping motor moves an optical pickup in a radial direction of an optical disc, a position of the optical pickup in the radial direction of the optical disc can be identified with accuracy of a pulse feed amount by the stepping motor. However, this is insufficient to precisely record optional visible image information on the label plane.

Alternatively, a laser spot shifts by application of voltage to a tracking actuator; thus, the position of the optical pickup in the radial direction of the optical disc can be controlled. However, a shift amount of the laser spot in the radial direction is not increased linearly with respect to an amount of the applied voltage. Consequently, an accurate shift amount cannot be obtained due to variations in a tracking actuator and a driver integrated circuit.

An object of the present invention is to provide an optical disc recording/reproducing device for recording a visible image by means of a heat-sensitive coloring matter provided on a label plane having no track used for identifying a position of an optical pickup in a radial direction of an optical disc. With this optical disc recording/reproducing device, a visible image can be recorded on the label plane of the optical disc under precise control of movement of the optical pickup in the radial direction of the optical disc with accuracy exceeding a traverse feed amount of the optical pickup even when a tracking actuator and a driver integrated circuit are variable.

### MEANS FOR SOLVING THE PROBLEMS

According to a first aspect of the present invention, there is provided an optical disc recording/reproducing device for recording visible information on a visible information recording layer formed on a visible information recording plane of an optical disc while changing a physical structure of the visible information recording layer by irradiation with a laser beam from an optical pickup, the optical disc recording/reproducing device comprising: traverse feed means for moving the optical pickup in a radial direction of the optical disc; tracking actuator means for slightly shifting a recording/reproducing laser spot of the optical pickup in the radial direction of the optical disc; visible information recorded/unrecorded area detection means for determining whether a position of the visible information recording layer accessed by the optical pickup is a visible information recorded area or a visible information unrecorded area; rotational position detection means for detecting a rotational position of the optical disc; radial recording position control means for actuating the traverse feed means and the tracking actuator means and allowing the visible information recorded/unrecorded area detection means to search for an inner circumferential end of a visible information unrecorded area on which visible information is recorded subsequently, while using an initial position located near an inner circumference of the optical disc as a start point; and visible information recording control means for recording visible information to be written to the visible information recording layer by controlling the optical pickup in accordance with data of the visible information, a current position of the optical pickup in the radial direction of the optical disc, and coordinate information obtained from a result of the detection by the rotational position detection means.

According to a second aspect of the present invention, there is provided an optical disc recording/reproducing device comprising traverse feed means for moving an optical pickup in a radial direction of an optical disc including a digital information recording plane on which digital information is recorded thereon/reproduced therefrom and tracking actuator means for slightly shifting a recording/reproducing laser spot of the optical pickup in the radial direction of the optical disc, and recording visible information on a visible information recording layer formed on a visible information recording plane provided on a reverse side to the digital information recording plane of the optical disc while changing a physical structure of the visible information recording layer by irradiation with a laser beam from the optical pickup, the optical disc recording/reproducing device further comprising: visible information recorded/unrecorded area detection means for determining whether a position of the visible information recording layer accessed by the optical pickup is a visible information recorded area or a visible information unrecorded area; rotational position detection means for detecting a rotational position of the optical disc; radial recording position control means for initially recording visible image information on an initial position which is located near an inner circumference of the optical disc and is used as a start point, for allowing the tracking actuator means to gradually increase a shift amount of the recording/reproducing laser spot, thereby to shift the recording/reproducing laser spot in an outer circumferential direction of the optical disc and allowing the visible information recorded/unrecorded area detection means to search for an inner circumferential end of a visible information unrecorded area on which visible information is recorded subsequently, for returning the shift of the recording/reproducing laser spot by the tracking actuator means to a position near a center, actuating the traverse feed means and moving the optical pickup in the outer circumferential direction of the optical disc by a certain distance when the shift amount of the recording/reproducing laser spot by the tracking actuator means exceeds a certain level, and for allowing the tracking actuator means to gradually increase the shift amount of the recording/reproducing laser spot in the inner circumferential direction of the optical disc, allowing the visible information recorded/unrecorded area detection means to search for a visible information recorded area, allowing the tracking actuator means to gradually increase the shift amount of the recording/reproducing laser spot to shift the recording/reproducing laser spot in the outer circumferential direction of the optical disc and allowing the visible information recorded/unrecorded area detection means to search for an inner circumferential end of a visible information unrecorded area on which visible information is recorded subsequently when the visible information recorded/unrecorded area detection means determines that a current position is a visible information unrecorded area; and visible information recording control means for recording visible information to be written to the visible information recording layer by controlling the optical pickup in accordance with data of the visible information, a current position of the optical pickup in the radial direction of the optical disc, and coordinate information obtained from a result of the detection by the rotational position detection means.

According to a third aspect of the present invention, in the optical disc recording/reproducing device according the first aspect, the visible information recording control means detects a radial position reference area recorded on an inner circumferential side of the visible information recording plane, and starts to record visible information while using the radial position reference area as a start point.

According to a fourth embodiment of the present invention, in the optical disc recording/reproducing device according to the first aspect, the visible information recorded/unrecorded area detection means detects a visible information recorded area/a visible information unrecorded area through a threshold value determined based on a reflected laser beam level prepared in advance.

According to a fifth aspect of the present invention, in the optical disc recording/reproducing device according to the first aspect, the visible information recording control means records visible information to be written so as to modulate a pit pattern of the visible information so that visible information unrecorded areas are prevented from being continuously provided for a predetermined period of time or longer.

According to a sixth aspect of the present invention, there is provided a visible image recording control method of an optical disc recording/reproducing device for recording visible information on an optical disc including a digital information recording plane on which digital information is recorded thereon/reproduced therefrom and a visible information recording plane which is provided on a reverse side to the digital information recording plane and has a visible information recording layer formed thereon, while changing a physical structure of the visible information recording layer by irradiation with a laser beam from an optical pickup, the visible image recording control method comprising: a first step of initially recording visible image information on an initial position which is located near an inner circumference of the optical disc and is used as a start point; a second step, performed after performance of the first step, of actuating traverse feed means and tracking actuator means and allowing visible information recorded/unrecorded area detection means to search for an inner circumferential end of a visible information unrecorded area on which visible information is recorded subsequently; and a third step of recording visible information to be written to the visible information recording layer by controlling the optical pickup in accordance with data of the visible information, a current position of the optical pickup in a radial direction of the optical disc, and coordinate information obtained from a result of detection by rotational position detection means.

According to a seventh aspect of the present invention, there is provided a visible image recording control method of an optical disc recording/reproducing device for recording visible information on an optical disc including a digital information recording plane on which digital information is recorded thereon/reproduced therefrom and a visible information recording plane which is provided on a reverse side to the digital information recording plane and has a visible information recording layer formed thereon, while changing a physical structure of the visible information recording layer by irradiation with a laser beam from an optical pickup, the visible image recording control method comprising: a first step, in a state that the optical disc is attached to a spindle motor such that the visible information recording layer faces the optical pickup, of allowing traverse feed means to move the optical pickup to a reference position located near an innermost circumference of the optical disc and allowing tracking actuator means to shift a recording/reproducing laser spot of the optical pickup in a radial direction of the optical disc, thereby to record a visible image corresponding to the reference position; a second step of increasing a shift amount of the recording/reproducing laser spot by the tracking actuator means to shift the recording/reproducing laser spot in an outer circumferential direction of the optical disc, and detecting that the recording/reproducing laser spot is in a visible information unrecorded area based on the laser beam from the optical pickup; and a third step of recording visible information to be written to the visible information recording layer by controlling the optical pickup in accordance with data of the visible information, a current position of the optical pickup in the radial direction of the optical disc, and coordinate information obtained from a result of detection by rotational position detection means, wherein the visible image recording control method further comprises repeatedly performing an operation in the third step for recording a visible image corresponding to a subsequent position of the optical pickup in the radial direction of the optical disc in accordance with coordinate information in a circumferential direction of the optical disc until a shift amount of the recording/reproducing laser spot by the tracking actuator means exceeds a certain level, while maintaining a shift amount of the recording/reproducing laser spot by the tracking actuator means upon detection of the visible information unrecorded area in the second step, actuating the traverse feed means to move the optical pickup in an outer circumferential direction of the optical disc by a certain distance, returning the shift amount of the recording/reproducing laser spot by the tracking actuator means to zero again and allowing the traverse feed means to move the optical pickup in the outer circumferential direction of the optical disc when the shift amount of the recording/reproducing laser spot by the tracking actuator means exceeds a certain level, maintaining a shift amount of the recording/reproducing laser spot by the tracking actuator means upon detection of an interface between a visible information recorded area and a visible information unrecorded area by shift of the recording/reproducing laser spot through the tracking actuator means in the inner circumferential direction of the optical disc when visible information recorded/unrecorded area detection means determines that a current position is a visible information unrecorded area, and increasing the shift amount of the recording/reproducing laser spot by the tracking actuator means, thereby to shift the recording/reproducing laser spot in the outer circumferential direction of the optical disc and recording a visible image on the visible information recording plane of the optical disc in the third step when the visible information recorded/unrecorded area detection means determines that the current position is a visible information recorded area.

According to an eighth aspect of the present invention, in the visible image recording control method of an optical disc recording/reproducing device according to the sixth aspect, the first step includes detecting a radial position reference area recorded on an inner circumferential side of the visible information recording plane, and starting to record visible information while using the radial position reference area as a start point.

According to a ninth aspect of the present invention, in the visible image recording control method of an optical disc recording/reproducing device according to the sixth aspect, the second step includes detecting a visible information recorded area/a visible information unrecorded area through a threshold value determined based on a reflected laser beam level prepared in advance.

According to a tenth aspect of the present invention, in the visible image recording control method of an optical disc recording/reproducing device according to the sixth aspect, the first step or the third step includes modulating visible information to be written so that visible information unrecorded areas are prevented from being continuously provided for a certain period of time or longer.

According to an eleventh aspect of the present invention, there is provided an optical disc comprising: a digital information recording plane on which digital information is recorded thereon/reproduced therefrom; and a visible information recording plane which is provided on a reverse side to the digital information recording plane and has a visible information recording layer on which visible information is recorded by a change in physical structure thereof, such change being caused by irradiation with a laser beam from an optical pickup, wherein visible information serving as a reference for a position of the optical pickup in a radial direction of the optical disc is recorded on a position near an innermost circumference of the visible information recording layer to shift a recording position in an outer circumferential direction of the optical disc while using the visible information as a start point, thereby to successively record desired visible information.

### EFFECT OF THE INVENTION

With the optical disc recording/reproducing device according to the present invention, a visible image can be recorded on a label plane having no track used for identifying a position of an optical pickup in a radial direction of an optical disc, under precise control of movement of the optical pickup in the radial direction of the optical disc with accuracy exceeding a traverse feed amount of the optical pickup even when a tracking actuator and a driver integrated circuit are variable.

### BRIEF DESCRIPTION OF THE DRAWINGS

FIG. 1 is a perspective view showing an optical disc used in an optical disc recording/reproducing device in Embodiment 1 of the present invention.

FIG. 2 shows a configuration of the optical disc recording/reproducing device in Embodiment 1 of the present invention.

FIG. 3 is a flowchart showing visible image recording routines for a CPU 110 and a signal processing circuit 109 in Embodiment 1.

FIG. 4 is a perspective view showing an optical disc used in the optical disc recording/reproducing device in Embodiment 2 of the present invention.

FIG. 5 is a flowchart showing visible image recording routines for the CPU 110 and the signal processing circuit 109 in Embodiment 2.

### EXPLANATION OF SYMBOLS

202 Visible Information Recording Plane
203 Digital Information Recording Plane
101 Optical Disc
102 Optical Pickup
104 Tracking Drive Circuit
105 Traverse Drive Circuit
106 Spindle Motor
107 Spindle Driver
108 Reproduction Signal Processing Circuit
109 Signal Processing Circuit
109A Visible information recorded/unrecorded area means
109B Rotational Position Detection Means
109C Radial Recording Position Control Means
109D Visible information recording control means
110 CPU
113 Semiconductor laser diode
114 Objective Lens
115 Focus Drive System
116 Tracking Drive System
117 Photosensor
118 DC motor

### BEST MODE FOR CARRYING OUT THE INVENTION

Hereinafter, description will be given of specific embodiments of an optical disc recording/reproducing device and a visible image recording control method according to the present invention.

### EMBODIMENT 1

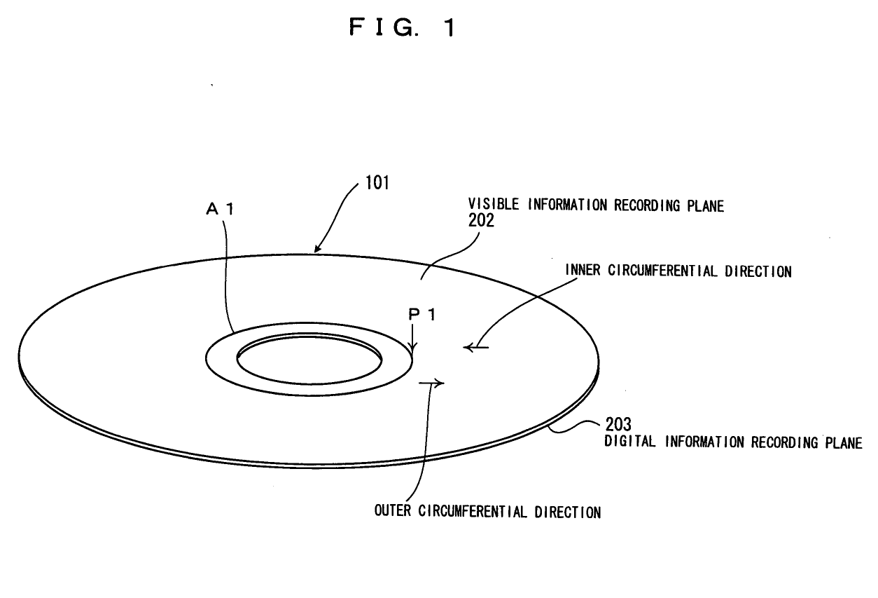

FIGS. 1 to 3 show Embodiment 1 of an optical disc recording/reproducing device according to the present invention.

FIG. 1 shows an optical disc 101 used in the present invention. The optical disc 101 used herein is based on CD-ROM standards.

The optical disc 101 has a digital information recording plane 203 formed on one side thereof and a visible information recording plane 202 formed on the other side thereof.

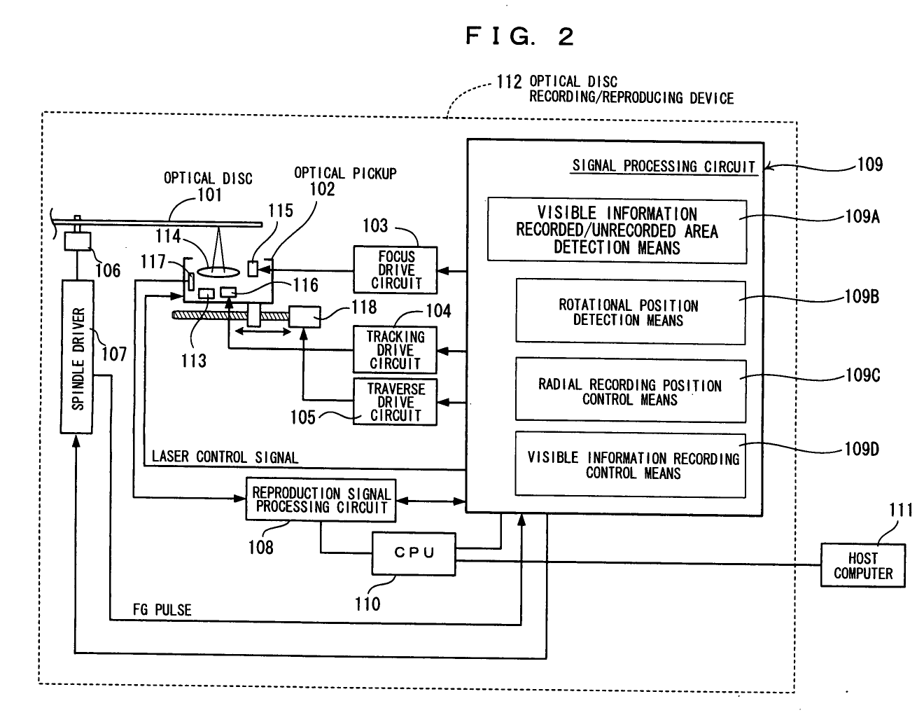

Upon use of the optical disc 101 in the optical disc recording/reproducing device shown in FIG. 2, the optical disc 101 is attached to a spindle motor 106 such that the digital information recording plane 203 or the visible information recording plane 202 faces an optical pickup 102.

In the optical disc 101 based on CD-ROM standards, the digital information recording plane 203 has pits formed spirally thereon. In the optical disc recording/reproducing device, the optical pickup 102 traces the pits by irradiating the pits with a laser beam; thus, a reproduction signal is obtained.

The visible information recording plane 202 includes a heat sensitive layer that causes a physical change by addition of heat, thereby to develop a color. The physical change is caused by irradiation of the heat sensitive layer with a laser beam from the optical pickup 102 at a certain level or above; thus, visible information is recorded on the visible information recording plane 202. The visible information recording plane 202 has no track.

The optical disc recording/reproducing device 112 shown in FIG. 2 accesses the digital information recording plane 203 of the optical disc 101, thereby to read/write digital information from/to the digital information recording plane 203. The optical disc recording/reproducing device 112 includes the optical pickup 102 for implementing the digital information read/write operation by accessing the optical disc 101 attached to and rotated by the spindle motor 106.

The typical optical pickup 102 includes a semiconductor laser diode 113, a focus drive system 115, a tracking drive system 116 and a photosensor 117. Herein, the semiconductor laser diode 113 emits a laser beam required for a read/write operation. The focus drive system 115 moves an objective lens 114 through a focus actuator coil so that the laser beam emitted from the semiconductor laser diode 113 comes into a focus on the digital information recording plane 203 or the visible information recording plane 202 of the optical disc 101. The tracking drive system 116 moves the objective lens 114 through a tracking actuator coil so as to trace the pits formed spirally on the digital information recording plane 203, and makes a fine adjustment. The photosensor 117 detects a laser beam reflected from the digital information recording plane 203.

A traverse drive circuit 105 performs traverse control so as to change a position of the optical pickup 102 in a radial direction of the optical disc 101 while using a DC motor 118 as a power supply source.

More specifically, the photosensor 117 outputs a reproduction signal to a reproduction signal processing circuit 108. The reproduction signal processing circuit 108 processes the reproduction signal to generate various servo error signals and reproduction signals (RF), and outputs the generated error signals to a signal processing circuit 109. The signal processing circuit 109 processes a focus error signal from among the various error signals to generate a focus drive signal. The signal processing circuit 109 drives the focus drive system 115 through a focus drive circuit 103 to perform focus control.

A spindle driver 107 allows the spindle motor 106 to rotate the optical disc 101. The normal spindle driver 107 controls rotation of the spindle motor 106 based on an output from a Hall element in the spindle motor 106. The spindle driver 107 has an output of an FG signal for processing the output from the Hall element and outputting a pulse to each area obtained by dividing one rotation by “N”. Based on the FG signal, the spindle driver 107 detects a rotational angle of the spindle motor 106 for each area obtained by dividing one rotation by “N”, and sets a rotational speed of the spindle motor 106, which is monitored by the signal processing circuit 109, at a constant rotational speed. The traverse drive circuit 105 and a tracking drive circuit 104 control a position of the laser beam emitted from the optical pickup 102 in the radial direction of the optical disc 101. Herein, the traverse drive circuit 105 drives the optical pickup 102 in the radial direction of the optical disc 101, and the tracking drive circuit 104 drives the objective lens 114 through the tracking drive system 116 in the radial direction of the optical disc 101 to finely control the position of the laser beam in the radial direction of the optical disc 101. In order to reproduce information from the digital information recording plane 203 in such a manner that an information track formed on the digital information recording plane 203 is irradiated with a laser beam, the signal processing circuit 109 controls the tracking drive circuit 104 by a tracking error signal generated from the reproduction signal by the reproduction signal processing circuit 108, thereby to finely control the position of the laser beam in the radial direction of the optical disc 101. Further, the signal processing circuit 109 controls the traverse drive circuit 105, thereby to control the movement of the optical pickup 102 in the radial direction of the optical disc 101.

A CPU 110 performs various controls for the optical disc recording/reproducing device 112, such as controls and adjustments for the reproduction signal processing circuit 108 and the signal processing circuit 109. A host computer 111 stores visible image information to be recorded on the visible information recording plane 202. The host computer 111 successively transmits the visible image information to the optical disc recording/reproducing device 112, and allows the optical disc recording/reproducing device 112 to perform a recording operation as follows.

Upon write of visible information, the optical disc 101 is attached to the spindle motor 106 such that the visible information recording plane 202 faces the optical pickup 102.

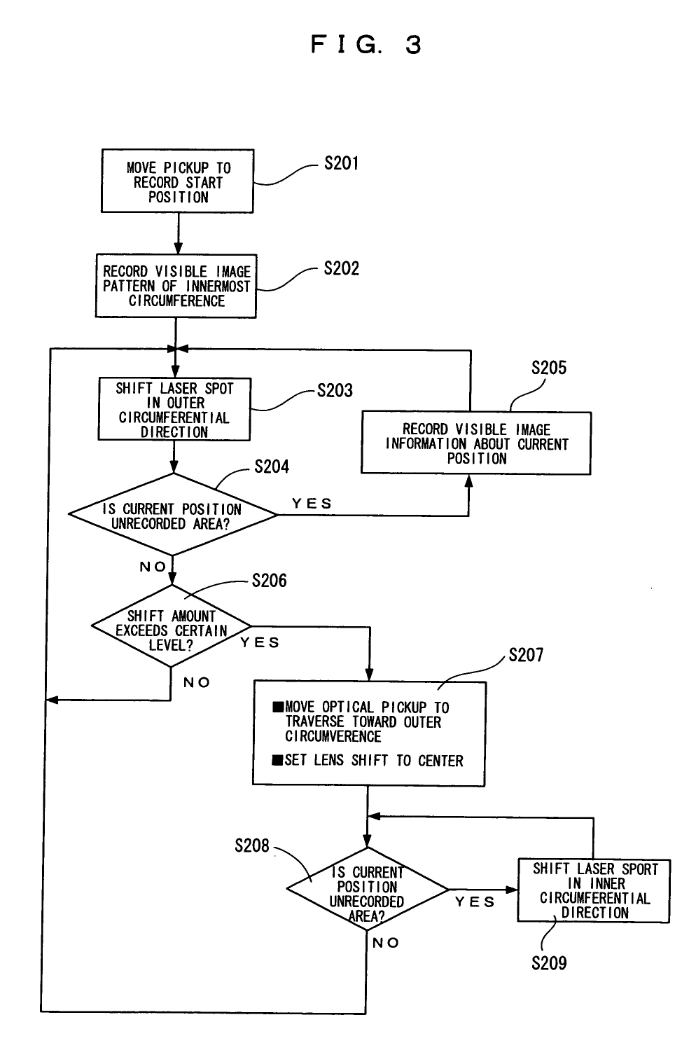

FIG. 3 shows routines performed by the CPU 110 and the signal processing circuit 109 in a case that the optical disc recording/reproducing device 112 actually records a visible image on the visible information recording plane 202 of the optical disc 101.

Prior to recording of a visible image, in step S201, the CPU 110 issues a command to the signal processing circuit 109. Based on the command, the signal processing circuit 109 activates the traverse drive circuit 105, so that the optical pickup 102 moves to a record start position P1 located near an innermost circumference of the optical disc 101. Typically, the optical pickup 102 moves to the innermost circumference of the optical disc 101 once and, then, moves in an outer circumferential direction of the optical disc 101 by a certain distance.

Next, in step S202, the CPU 110 inactivates the tracking drive circuit 104 so that the tracking drive system 116 makes no fine adjustment for the laser beam in a tracking direction (lens shift: center). Then, the CPU 110 records a visible image on an area corresponding to one rotation of the optical disc 101 at the record start position P1 without shifting a laser spot.

Herein, in accordance with an instruction from the CPU 110, a rotational position detection means 109B of the signal processing circuit 109 detects the rotational position of the optical disc 101 based on the FG pulse.

When the CPU 110 receives, from the host computer 111, visible image data corresponding to a current position of the optical pickup 102 in the radial direction of the optical disc 101, a visible information recording control means 109D of the signal processing circuit 109 records the visible image in accordance with an instruction from the CPU 110. More specifically, the visible information recording control means 109D converts the received visible image data to a pit pattern modulated so that spaces are not continuously provided over a certain period of time or longer. This converting operation is normally performed by dedicated hardware provided in the signal processing circuit 109. Based on the pit pattern obtained by the converting operation and the rotational position information obtained from the FG pulse outputted from the spindle driver 107, the signal processing circuit 109 outputs a laser control signal in order to change a laser light emission level of the optical pickup 102; thus, a desired pit pattern is recorded on the visible information recording plane 202 of the optical disc 101. In the visible information recording plane 202, the position having the visible image information recorded thereon becomes a recorded area.

In step S203, the signal processing circuit 109 inactivates the traverse drive circuit 105 so that the DC motor 118 is not driven. Further, the signal processing circuit 109 activates the tracking drive circuit 104 so that the tracking drive system 116 moves the objective lens 114, that is, gradually shifts the laser spot in the outer circumferential direction of the optical disc 101. Then, the signal processing circuit 109 performs the processes in steps S203 to S205 to increase a shift amount of the laser spot until a current position is detected as an unrecorded area in step S204.

Herein, in accordance with an instruction from the CPU 110, a visible information recorded/unrecorded area detection means 109A of the signal processing circuit 109 detects an unrecorded area in step S204. Normally, a recorded area having a pit pattern of visible image information recorded thereon has a lowered average reflectivity. Therefore, the visible information recorded/unrecorded area detection means 109A detects an unrecorded area based on an amount of a laser beam reflected from the visible information recording plane 202 of the optical disc 101. In order to enhance detection accuracy, alternatively, an amount of a reflected laser beam in a recorded area and an amount of a reflected laser beam in an unrecorded area are measured in advance; thus, a threshold value may be determined based on the measured values. In addition, if a laser spot is movable to an unrecorded area or a recorded area upon attachment of an optical disc 101, an amount of a reflected laser beam in the unrecorded area and an amount of a reflected laser beam in the recorded area are measured every time the optical disc 101 is replaced with new one; thus, a precise operation can be performed without variations in reflectivity of the respective discs.

If it is determined that the laser spot is in an unrecorded area in step S204, a visible image pit pattern at the corresponding position in the radial direction of the optical disc 101 is recorded in step S205 while the shift amount of the laser spot is maintained. Then, an operation for searching for an unrecorded area is performed again in step S204 after performance of the process in step S203.

Upon detection in step S206 that the shift amount of the laser spot by the tracking drive system 116 exceeds a certain level, in accordance with an instruction from the CPU 110, the traverse drive circuit 105 drives the DC motor 118 to move the optical pickup 102 in the outer circumferential direction of the optical disc 101 by a certain distance in step S207; thus, the shift amount of the laser spot by the tracking drive circuit 104 becomes zero again.

In order to move the optical pickup 102 in the outer circumferential direction of the optical disc 101, the shift amount of the laser spot is determined in advance from accuracy in amount of a movement of the optical pickup 102 by the traverse drive circuit 105 and an allowance value of the shift amount of the laser spot by the tracking drive circuit 104. The allowance value of the shift amount may be determined from a degree of deterioration in recording/reproducing efficiency when the shift amount is increased, a movable range of the objective lens 114, and the like.

Next, in step S208, the signal processing circuit 109 determines whether a current position, that is, a position to which the optical pickup 102 moves is a recorded area or an unrecorded area in a state that the shift amount of the laser spot is zero (lens shift: center). If it is determined that the current position is determined as an unrecorded area, the signal processing circuit 109 inactivates the traverse drive circuit 105 and activates the tracking drive circuit 104, thereby to gradually shift the laser spot in an inner circumferential direction of the optical disc 101 in step S209, in order to search for an outermost circumferential end of a recorded area. Then, the signal processing circuit 109 performs the processes in steps S208 and S209 repeatedly to increase the shift amount in the inner circumferential direction of the optical disc 101 until the signal processing circuit 109 determines that the current position is a recorded area in step S208. Herein, a radial recording position control means 109C of the signal processing circuit 109 searches for an inner circumferential end of a recorded area in accordance with an instruction from the CPU 110.

After determination that the current position is a recorded area by the shift of the laser spot in the inner circumferential direction of the optical disc 101 in step S208 or upon determination that the current position is a recorded area by the shift of the laser spot in the inner circumferential direction of the optical disc 101 in step S208, the signal processing circuit 109 inactivates the traverse drive circuit 105 and activates the tracking drive circuit 104 to gradually shift the laser spot in the outer circumferential direction of the optical disc 101 in step S203, in order to search for an innermost circumferential end of an unrecorded area. Then, the signal processing circuit 109 increases the shift amount in the inner circumferential direction of the optical disc 101 until the signal processing circuit 109 determines that the current position is unrecorded area in step S204. Thus, an operation for recording a visible image is performed until completion of recording of desired visible image information.

As described above, a visible image can be recorded on the heat-sensitive coloring matter provided on the label plane having no track used for identifying the position of the optical pickup 102 in the radial direction of the optical disc 101, by irradiation of the heat-sensitive coloring matter with a laser beam from the optical pickup 102, under precise control of movement of the optical pickup 102 in the radial direction of the optical disc 101 with accuracy exceeding a traverse feed amount of the optical pickup 102 by the traverse drive circuit 105 even when a tracking actuator and a driver integrated circuit are variable.

In this embodiment, as an example, visible image information is recorded on a visible information recording layer provided on one side of an optical disc based on CD-ROM standards. Similarly, the present invention is applicable to a system that records a visible image on an optical disc having a heat-sensitive visible image recording layer.

Also in this embodiment, as an example, visible information is unconditionally recorded on an optical disc 101 loaded into the optical disc recording/reproducing device 112. However, the signal processing circuit 109 determines whether or not a current position is a recorded area upon movement of the optical pickup 102 to the record start position P1 in step S201. Herein, if it is determined that the current position is a recorded area, the optical disc 101 is determined as a visible information recorded disc; thus, the recording operation may be stopped.

If there is no difference exceeding a certain amount between an amount of a reflected laser beam in an unrecorded area and an amount of a reflected laser beam in a recorded area, a corresponding optical disc is determined as a visible information recorded disc; thus, the recording operation may be stopped.

Herein, a first step of initially recording visible image information on an initial position which is located near an inner circumference of the optical disc and is used as a start point corresponds to steps S201 and S202.

A second step, performed after performance of the first step, of actuating traverse feed means and tracking actuator means and allowing visible information recorded/unrecorded area detection means to search for an inner circumferential end of an unrecorded area on which visible information is recorded subsequently corresponds to steps S203, S204, S206, S207, S208 and S209.

A third step of recording visible information to be written to the visible information recording layer by controlling the optical pickup in accordance with data of the visible information, a current position of the optical pickup in a radial direction of the optical disc, and coordinate information obtained from a result of detection by rotational position detection means corresponds to step S205.

In this embodiment, the visible information record start position is located near the innermost circumference of the optical disc 101, and visible information is gradually recorded on the visible information recording plane 202 of the optical disc 101 from the visible information record start position in the outer circumferential direction of the optical disc 101 by irradiation of the visible information recording plane 202 with a laser beam emitted from the optical pickup 102. However, the visible information record start position may be located near the outermost circumference of the optical disc 101, and visible information can be gradually recorded on the visible information recording plane 202 of the optical disc 101 from the visible information record start position in the inner circumferential direction of the optical disc 101 by irradiation of the visible information recording plane 202 with a laser beam emitted from the optical pickup 102.

### EMBODIMENT 2

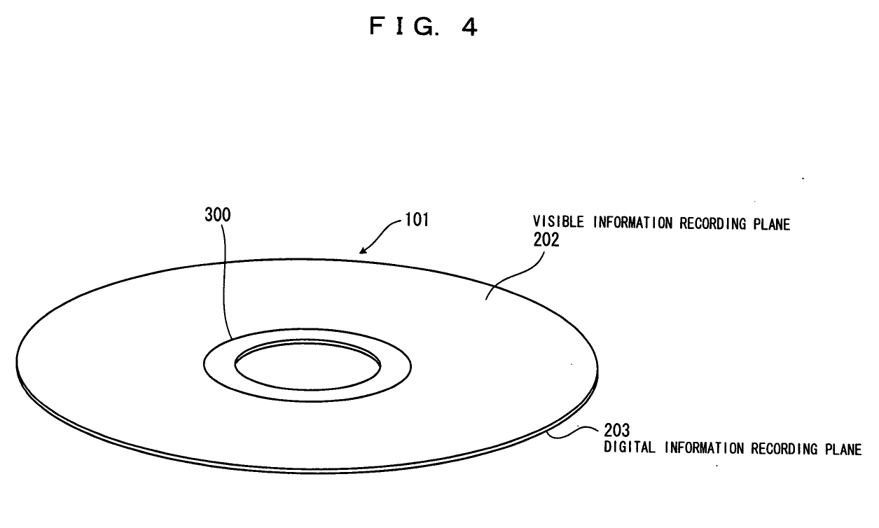

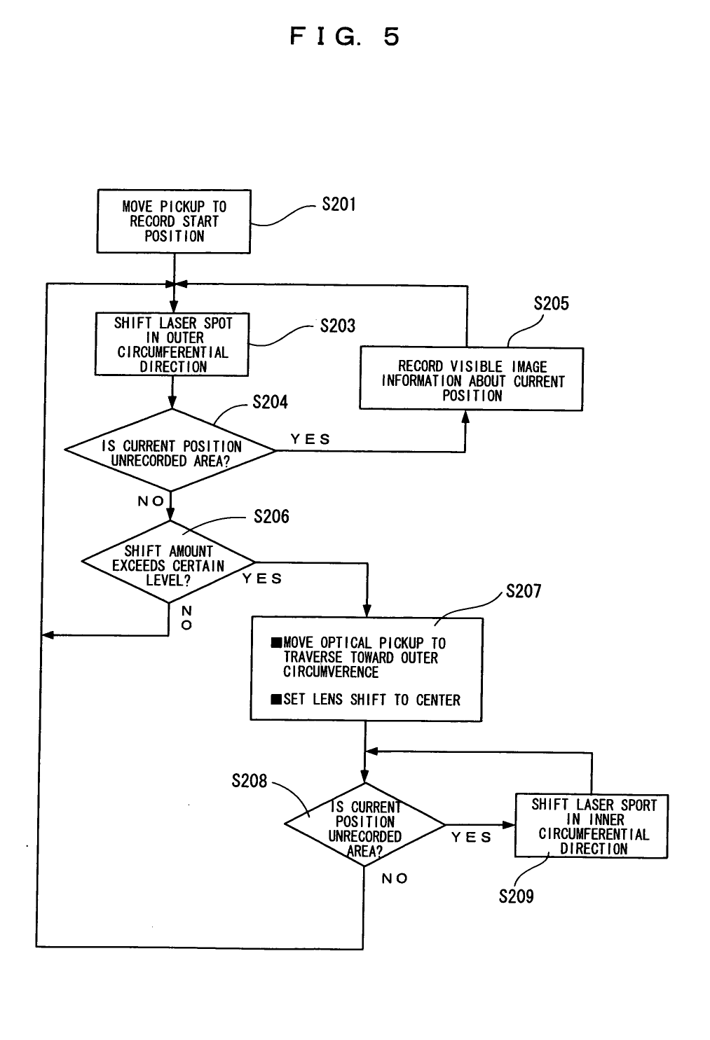

FIGS. 4 and 5 show Embodiment 2 of the optical disc recording/reproducing device according to the present invention.

FIG. 4 shows an optical disc 101 used in Embodiment 2. The optical disc 101 used herein is different from that used in Embodiment 1 shown in FIG. 1 in the following point. That is, in the optical disc 101 used in Embodiment 2, a visible information recorded area 300 is provided in advance over a certain width at a position near an innermost circumference of a visible information recording plane 202. Visible image information to be recorded on the visible information recorded area 300 is not particularly limited, and examples thereof include random pit patterns, data indicative of an attribute of an optical disc, visible images, and the like.

A schematic configuration of the optical disc recording/reproducing device in Embodiment 2 is similar to that of the optical disc recording/reproducing device in Embodiment 1 shown in FIG. 2. However, routines performed by the CPU 110 and the signal processing circuit 109 are changed as shown in FIG. 5.

Herein, specific description will be given of the optical disc recording/reproducing device 112 that actually records a visible image on the visible information recording plane 202 of the optical disc 101.

Prior to start of the recording, in step S201, the CPU 110 issues a command to the signal processing circuit 109. Based on the command, the signal processing circuit 109 activates the traverse drive circuit 105, so that the optical pickup 102 moves to a record start position located near the innermost circumference of the optical disc 101. Typically, the optical pickup 102 moves to the innermost circumference of the optical disc 101 once and, then, moves in an outer circumferential direction of the optical disc 101 by a certain distance. At the record start position, a laser spot is in the visible information recorded area 300.

Next, in step S203, the signal processing circuit 109 inactivates the traverse drive circuit 105 and activates the tracking drive circuit 104, thereby to gradually shift the laser spot in the outer circumferential direction of the optical disc 101. Then, the signal processing circuit 109 increases the shift amount of the laser spot until the signal processing circuit 109 determines that a current position is an unrecorded area in step S204. Normally, a recorded area having a pit pattern of visible image information recorded thereon has a lowered average reflectivity. Therefore, the signal processing circuit 109 can detect an unrecorded area based on an amount of a laser beam reflected from the visible information recording plane 202 of the optical disc 101. In order to enhance detection accuracy, an amount of a reflected laser beam in a recorded area and an amount of a reflected laser beam in an unrecorded area are measured in advance; thus, a threshold value may be determined from the measured values. Herein, an amount of a reflected laser beam in the visible information recorded area 300 is measured, and an amount of a reflected laser beam in an unrecorded area at a position moved in the outer circumferential direction by a certain distance is measured every time the optical disc 101 is replaced with new one. In addition, if there is no difference exceeding a certain amount between an amount of a reflected laser beam in an unrecorded area and an amount of a reflected laser beam in a recorded area, the optical disc 101 is determined as a visible information recorded disc, and the recording operation may be stopped.

If the laser spot is in an unrecorded area, a visible image pit pattern at the corresponding position in the radial direction of the optical disc 101 is recorded in step S205 while the shift amount of the laser spot is maintained. Then, an operation for searching for an unrecorded area is performed again in step S204.

Upon determination in step S206 that the shift amount of the laser spot exceeds a certain level, the signal processing circuit 109 activates the traverse drive circuit 105, so that the optical pickup 102 moves in the outer circumferential direction of the optical disc 101 by a certain distance in step S207. Thus, the shift amount of the laser spot by the tracking drive circuit 104 becomes zero again.

In order to move the optical pickup 102 in the outer circumferential direction of the optical disc 101, the shift amount of the optical spot is determined in advance from accuracy in amount of a movement of the optical pickup 102 by the traverse drive circuit 105 and an allowance value of the shift amount of the laser spot by the tracking drive circuit 104. The allowance value of the shift amount may be determined from a degree of deterioration in recording/reproducing efficiency when the shift amount is increased, a movable range of the objective lens 114, and the like.

Next, in step S208, the signal processing circuit 109 determines whether a current position, that is, a position to which the optical pickup 102 moves is a recorded area or an unrecorded area in a state that the shift amount of the laser spot is zero. If it is determined that the current position is determined as an unrecorded area, the signal processing circuit 109 inactivates the traverse drive circuit 105 and activates the tracking drive circuit 104, thereby to gradually shift the laser spot in an inner circumferential direction of the optical disc 101 in step S209, in order to search for an outermost circumferential end of a recorded area. Then, the signal processing circuit 109 increases the shift amount in the inner circumferential direction of the optical disc 101 until the signal processing circuit 109 determines that the current position is a recorded area in step S208. After determination that the current position is a recorded area or upon determination that the current position is a recorded area in step S208, the signal processing circuit 109 inactivates the traverse drive circuit 105 and activates the tracking drive circuit 104 to gradually shift the laser spot in the outer circumferential direction of the optical disc 101 in step S203, in order to search for an innermost circumferential end of an unrecorded area. Then, the signal processing circuit 109 increases the shift amount in the inner circumferential direction of the optical disc 101 until the signal processing circuit 109 determines that the current position is unrecorded area in step S204. Thus, an operation for recording a visible image is performed until completion of recording of desired visible image information.

In this embodiment, as an example, visible image information is recorded on a visible information recording layer provided on one side of an optical disc based on CD-ROM standards. Similarly, the present invention is applicable to a system that records a visible image on an optical disc having a heat-sensitive visible image recording layer.

According to Embodiment 2, as described above, it is possible to provide an optical disc recording/reproducing device and a visible image recording control method of the optical disc recording/reproducing device. In the optical disc recording/reproducing device for recording a visible image on a heat-sensitive coloring matter provided on a label plane having no track for identifying a position of an optical pickup in a radial direction of an optical disc, precise control of a movement of the optical pickup in the radial direction of the optical disc is performed with accuracy exceeding a traverse feed amount even when a tracking actuator and a driver integrated circuit are variable. Further, measurement for determination of a recorded area or an unrecorded area is performed with certainty; thus, a visible image is recorded without erroneous recording.

In Embodiments 1 and 2, traverse feed means for moving an optical pickup in a radial direction of an optical disc includes the traverse drive circuit 105, the DC motor 118 and the like.

In addition, tracking actuator means for slightly shifting a recording/reproducing laser spot of the optical pickup in the radial direction of the optical disc includes the tracking drive circuit 104 and the tracking drive system 116.

### INDUSTRIAL APPLICABILITY

An optical disc recording/reproducing device or a visible image recording control method thereof according to the present invention, and an optical disc provide the following advantage. That is, upon recording of a visible image on an optical disc including a visible information recording layer which is formed on a reverse side to a digital information recording plane and on which visible information is recorded by a change in its physical structure through irradiation with a laser beam from an optical pickup, positional control of the optical pickup in a tracking direction can be performed precisely without addition of a special device even when a tracking actuator and a driver integrated circuit are variable.

1. An optical disc recording/reproducing device for recording visible information on a visible information recording layer formed on a visible information recording plane of an optical disc while changing a physical structure of the visible information recording layer by irradiation with a laser beam from an optical pickup,
the optical disc recording/reproducing device comprising:
traverse feed means for moving the optical pickup in a radial direction of the optical disc;
tracking actuator means for slightly shifting a recording/reproducing laser spot of the optical pickup in the radial direction of the optical disc;
visible information recorded/unrecorded area detection means for determining whether a position of the visible information recording layer accessed by the optical pickup is a visible information recorded area or a visible information unrecorded area;
rotational position detection means for detecting a rotational position of the optical disc;
radial recording position control means for actuating the traverse feed means and the tracking actuator means and allowing the visible information recorded/unrecorded area detection means to search for an inner circumferential end of a visible information unrecorded area on which visible information is recorded subsequently, while using an initial position located near an inner circumference of the optical disc as a start point; and
visible information recording control means for recording visible information to be written to the visible information recording layer by controlling the optical pickup in accordance with data of the visible information, a current position of the optical pickup in the radial direction of the optical disc, and coordinate information obtained from a result of the detection by the rotational position detection means.

2. An optical disc recording/reproducing device comprising traverse feed means for moving an optical pickup in a radial direction of an optical disc including a digital information recording plane on which digital information is recorded thereon/reproduced therefrom and tracking actuator means for slightly shifting a recording/reproducing laser spot of the optical pickup in the radial direction of the optical disc, and recording visible information on a visible information recording layer formed on a visible information recording plane provided on a reverse side to the digital information recording plane of the optical disc while changing a physical structure of the visible information recording layer by irradiation with a laser beam from the optical pickup,
the optical disc recording/reproducing device further comprising:
visible information recorded/unrecorded area detection means for determining whether a position of the visible information recording layer accessed by the optical pickup is a visible information recorded area or a visible information unrecorded area;
rotational position detection means for detecting a rotational position of the optical disc;
radial recording position control means for initially recording visible image information on an initial position which is located near an inner circumference of the optical disc and is used as a start point, for allowing the tracking actuator means to gradually increase a shift amount of the recording/reproducing laser spot, thereby to shift the recording/reproducing laser spot in an outer circumferential direction of the optical disc and allowing the visible information recorded/unrecorded area detection means to search for an inner circumferential end of a visible information unrecorded area on which visible information is recorded subsequently, for returning the shift of the recording/reproducing laser spot by the tracking actuator means to a position near a center, actuating the traverse feed means and moving the optical pickup in the outer circumferential direction of the optical disc by a certain distance when the shift amount of the recording/reproducing laser spot by the tracking actuator means exceeds a certain level, and for allowing the tracking actuator means to gradually increase the shift amount of the recording/reproducing laser spot in the inner circumferential direction of the optical disc, allowing the visible information recorded/unrecorded area detection means to search for a visible information recorded area, allowing the tracking actuator means to gradually increase the shift amount of the recording/reproducing laser spot to shift the recording/reproducing laser spot in the outer circumferential direction of the optical disc and allowing the visible information recorded/unrecorded area detection means to search for an inner circumferential end of a visible information unrecorded area on which visible information is recorded subsequently when the visible information recorded/unrecorded area detection means determines that a current position is a visible information unrecorded area; and
visible information recording control means for recording visible information to be written to the visible information recording layer by controlling the optical pickup in accordance with data of the visible information, a current position of the optical pickup in the radial direction of the optical disc, and coordinate information obtained from a result of the detection by the rotational position detection means.

3. The optical disc recording/reproducing device according to claim 1, wherein the visible information recording control means detects a radial position reference area recorded on an inner circumferential side of the visible information recording plane, and starts to record visible information while using the radial position reference area as a start point.

4. The optical disc recording/reproducing device according to claim 1, wherein the visible information recorded/unrecorded area detection means detects a visible information recorded area/a visible information unrecorded area through a threshold value determined based on a reflected laser beam level prepared in advance.

5. The optical disc recording/reproducing device according to claim 1, wherein the visible information recording control means records visible information to be written so as to modulate a pit pattern of the visible information so that visible information unrecorded areas are prevented from being continuously provided for at least a predetermined period of time.

6. A visible image recording control method of an optical disc recording/reproducing device for recording visible information on an optical disc including a digital information recording plane on which digital information is recorded thereon/reproduced therefrom and a visible information recording plane which is provided on a reverse side to the digital information recording plane and has a visible information recording layer formed thereon, while changing a physical structure of the visible information recording layer by irradiation with a laser beam from an optical pickup,
the visible image recording control method comprising:
a first step of initially recording visible image information on an initial position which is located near an inner circumference of the optical disc and is used as a start point;
a second step, performed after performance of the first step, of actuating traverse feed means and tracking actuator means and allowing visible information recorded/unrecorded area detection means to search for an inner circumferential end of a visible information unrecorded area on which visible information is recorded subsequently; and
a third step of recording visible information to be written to the visible information recording layer by controlling the optical pickup in accordance with data of the visible information, a current position of the optical pickup in a radial direction of the optical disc, and coordinate information obtained from a result of detection by rotational position detection means.

7. A visible image recording control method of an optical disc recording/reproducing device for recording visible information on an optical disc including a digital information recording plane on which digital information is recorded thereon/reproduced therefrom and a visible information recording plane which is provided on a reverse side to the digital information recording plane and has a visible information recording layer formed thereon, while changing a physical structure of the visible information recording layer by irradiation with a laser beam from an optical pickup,
the visible image recording control method comprising:
a first step, in a state that the optical disc is attached to a spindle motor such that the visible information recording layer faces the optical pickup, of allowing traverse feed means to move the optical pickup to a reference position located near an innermost circumference of the optical disc and allowing tracking actuator means to shift a recording/reproducing laser spot of the optical pickup in a radial direction of the optical disc, thereby to record a visible image corresponding to the reference position;
a second step of increasing a shift amount of the recording/reproducing laser spot by the tracking actuator means to shift the recording/reproducing laser spot in an outer circumferential direction of the optical disc, and detecting that the recording/reproducing laser spot is in a visible information unrecorded area based on the laser beam from the optical pickup; and
a third step of recording visible information to be written to the visible information recording layer by controlling the optical pickup in accordance with data of the visible information, a current position of the optical pickup in the radial direction of the optical disc, and coordinate information obtained from a result of detection by rotational position detection means,
wherein the visible image recording control method further comprises repeatedly performing an operation in the third step for recording a visible image corresponding to a subsequent position of the optical pickup in the radial direction of the optical disc in accordance with coordinate information in a circumferential direction of the optical disc until a shift amount of the recording/reproducing laser spot by the tracking actuator means exceeds a certain level, while maintaining a shift amount of the recording/reproducing laser spot by the tracking actuator means upon detection of the visible information unrecorded area in the second step, actuating the traverse feed means to move the optical pickup in an outer circumferential direction of the optical disc by a certain distance, returning the shift amount of the recording/reproducing laser spot by the tracking actuator means to zero again and allowing the traverse feed means to move the optical pickup in the outer circumferential direction of the optical disc when the shift amount of the recording/reproducing laser spot by the tracking actuator means exceeds a certain level, maintaining a shift amount of the recording/reproducing laser spot by the tracking actuator means upon detection of an interface between a visible information recorded area and a visible information unrecorded area by shift of the recording/reproducing laser spot through the tracking actuator means in the inner circumferential direction of the optical disc when visible information recorded/unrecorded area detection means determines that a current position is a visible information unrecorded area, and increasing the shift amount of the recording/reproducing laser spot by the tracking actuator means, thereby to shift the recording/reproducing laser spot in the outer circumferential direction of the optical disc and recording a visible image on the visible information recording plane of the optical disc in the third step when the visible information recorded/unrecorded area detection means determines that the current position is a visible information recorded area.

8. The visible image recording control method of the optical disc recording/reproducing device according to claim 6, wherein the first step includes detecting a radial position reference area recorded on an inner circumferential side of the visible information recording plane, and starting to record visible information while using the radial position reference area as a start point.

9. The visible image recording control method of the optical disc-recording/reproducing device according to claim 6, wherein the second step includes detecting a visible information recorded area/a visible information unrecorded area through a threshold value determined based on a reflected laser beam level prepared in advance.

10. The visible image recording control method of the optical disc recording/reproducing device according to claim 6, wherein one of the first step and the third step includes modulating visible information to be written so that visible information unrecorded areas are prevented from being continuously provided for at least a certain period of time.

11. An optical disc comprising:
a digital information recording plane on which digital information is recorded thereon/reproduced therefrom; and
a visible information recording plane which is provided on a reverse side to the digital information recording plane and has a visible information recording layer on which visible information is recorded by a change in physical structure thereof, such change being caused by irradiation with a laser beam from an optical pickup,
wherein visible information serving as a reference for a position of the optical pickup in a radial direction of the optical disc is recorded on a position near an innermost circumference of the visible information recording layer to shift a recording position in an outer circumferential direction of the optical disc while using the visible information as a start point, thereby to successively record desired visible information.
